(19) United States
(12) Patent Application Publication
(10) Pub. No.: US 2007/0185773 A1
(43) Pub. Date: Aug. 9, 2007

(54) Method for the management of offers related to load transportation services

(76) Inventors: Mateo Dominguez Luque, Barbera del Valles (ES); Miquel Gabriel Villanueva, Calella de Mar (ES)

Correspondence Address: RATNERPRESTIA, P O BOX 980, VALLEY FORGE, PA, 19482-0980, US

(21) Appl. No.: 11/336,517

(22) Filed: Jan. 20, 2006

(51) Int. Cl. G06Q 30/00

(52) U.S. Cl. 705/26

(57) ABSTRACT

Method for the management of offers related to load transportation services. It comprises following steps: a) providing to a server a information items relating to firms needing transportation services, said information items including, per firm, at least a firm identifier and at least detail of one geographical zone of transport destination; b) making available information items about firm transport requirements to carriers, said carriers also providing to said main computing means a carrier identifier and carrying capacity; c) conveying said carriers to said main computing means, personalized offers taking into account information of step b), directed to any number of said firms, d) making available said personalized offers to said firms they are directed to using a computer network to realize said steps a), b) and c) of providing and making available said information items and conveying said offers.

### FIELD OF THE INVENTION

This invention relates to a method based on a computer program for managing offers related to load transportation services between a plurality of firms having at a given time loads to be transported to one or more destinies and a plurality of carriers prepared and capable to transport said loads.

### BACKGROUND OF THE INVENTION

There are many documents describing methods or procedures intended to improve the logistics between shippers or firms with goods to be transported, and the carriers able to transport them. Usually the communication between both shippers and carriers in order to fit the first ones shipment orders with the second ones transport offers, are deficient.

Some proposals aimed to enhance said communication in order to achieve a more efficient shipments of goods, matching more appropriately shippers desires with carriers concerning handled commodities are following detailed:

U.S. Pat. No. 5,758,329 concerns to a system and a method for managing customer orders by creating a network data base, downloading customer order data to terminals to create load criteria; sorting said load criteria; assembling loads; selecting carriers for said loads from a plurality of available carriers; routing said loads based upon said assembled loads and said selected carriers; rerouting said loads in transit to adjust for less than full loads as delivery criteria change; and generating data to assemble said loads.

U.S. Pat. No. 6,915,268 concerns to a transport logistics systems for managing the shipments of goods supplied from a plurality of different shippers by a plurality of carriers, said system comprising different modules relating proposals made by shippers for respective shipments of goods (purchasing, scheduling, contract administration and financial modules), a network configured to transfer information between said modules, and computers accessing said network to process said information transferred by and configured to execute a computer program of said modules.

None of the cited documents relates to managing or optimizing with some strategy offers but simply to managing shipment orders.

No proposal is known to the inventors to create a virtual scenario wherein both firms and carriers connected through a computer network and under control of at least a main computing means or server are able to better achieve their goals, i.e. obtain a superior or higher price and an adaptation of the offer to the need or requirement and optimize the use of any kind of transportation means at any moment.

In addition the invention provides a method that allow that a firm using it mainly receive offers that really fits with the true necessities or demands thereof, i.e. personalized offers addressing several load criterion matching the specific requirements of the firms at any given moment.

### SUMMARY OF THE INVENTION

It appears of interest to provide a method aimed to managing offers and in particular providing a virtual scenario in which carriers prepared to provide transportation services and firms needing them can easily met, said firms being able under such an scenario to present their transportation needs that are exposed in a detailed and at the same time very easy way to grasp, so that from such information said firms can receive personalized offers related to transportation services that really fit to the true necessities of the firms.

The term “firm” used here covers any kind of firm or person with an activity involving transport of diverse products.

The method also provides the chance of obtaining a precise monitoring of the different steps of carry out of one or more transportation services once the offers involving them have been chosen and accepted by both parts.

The present invention concerns to a method comprising:

a) providing to a main computing means or server equipped with a program a list of information items relating to firms needing transportation services, said information items including, per firm, at least a firm identifier and at least detail of one geographical zone or area including at least a transport destination, required;

b) making available said information items placed at said main computing means to carriers that also provide to said main computing means when they are interested in using this method, information items including, per carrier, at least a carrier identifier and carrying capacity;

c) conveying said carriers to said main computing means, offers to any number of said firms, each offer containing at least a part being personalized by including at least a carrier load criterion including said at least one geographical zone of transport destinations required by the corresponding firm;

d) making available said personalized offers to said firms they are directed to.

A connection through at least a computer network such as an Internet network is used to realize said steps a), b) and c) of providing and making available said information items and conveying said offers.

As per a preferred embodiment of the invention carries can not seen offers of other carriers conveyed to a same firm and related to the same offer. In general carrier are not capable by this method of acquire information about the offers of other carriers in the field.

According to a preferred embodiment of this invention before said step d) and using at least part of said main computing means resources, it is proceeded to process through at least a dedicated computer program said personalized offers, said at least one carrier load criterion and said list of firms information, to create a database of offers related to firms.

Also as per a favorite embodiment said step d) includes sending said offers to corresponding firms under petition thereof.

To better implement the method it comprises to do by said main computing means, previously to said making available of said step d) and working on said database of offers related to firms, a sorting of said personalized offers, automatically or requested by a firm.

Therefore this method provides a virtual scenario wherein both firms and carriers can freely interchange information in a very easy way manner, the firms obtaining a plurality of offers in a way that facilitates a quick and accurate selection thereof because the offers have been prepared taking into account the specific necessities and variety of any firm. Moreover the offers are sorted following some filtering criteria that any firm can implement at their convenience.

### BRIEF DESCRIPTION OF THE DRAWINGS

Other characteristics of the invention will be shown more clearly starting from the following description of some embodiments referring to the enclosed figures, which are to be understood in an illustrating, however, not limiting way, in which:

FIG. 1 is a schematic view showing a carrier communicated with two firms through a server, with a respective database, for doing some steps of the method proposed, for an embodiment,

FIG. 2 is another schematic view which represents the contents of a transport offer, made by a carrier, for an embodiment,

FIG. 3 is another schematic view showing a firm communicated with three carriers through a server, with a respective database, for doing some steps of the method proposed, for an embodiment,

FIG. 4 is another schematic view which represents the contents of a transport order, made by a firm, for an embodiment,

FIG. 5 is a diagrammatic view which represents the communication between a firm and a carrier, and some actions carried out by some of the steps of the method proposed for an embodiment, and

FIG. 6 is another diagrammatic view which also represents the communication between a firm and a carrier, and some actions carried out by some of the steps of the method proposed for an embodiment, in

### DETAILED DESCRIPTION OF EMBODIMENTS OF THE INVENTION

In order to describe more particularly the present invention with additional specificity and detail, different embodiments will be next portrayed. It must be understood that these descriptions only refer to typical embodiments of the invention and are not therefore to be considered to be limiting of its scope.

The indications in the following figures are words and phrases which meaning must be taken as an indication of the actors and actions included in the method proposed.

First of all say that the steps of the method described before and the ones which will be described below, are, for a preferred embodiment, exhibited by a graphical environment to the carriers and firms, being the mentioned computer network a network such as Internet, being in that case the carriers, having carriers computing means, and the firms, having firms computing means, connected through Internet to a web page or another application (dependant—for at least working online—on the computer program installed in the main computing means) which delivers said graphical environment in an interactive way, so they (both carriers and firms) can input data from their own computers toward the main computing means, and view changes in their respective displays in the form of said graphic environment reflecting changes produced by said data inputted.

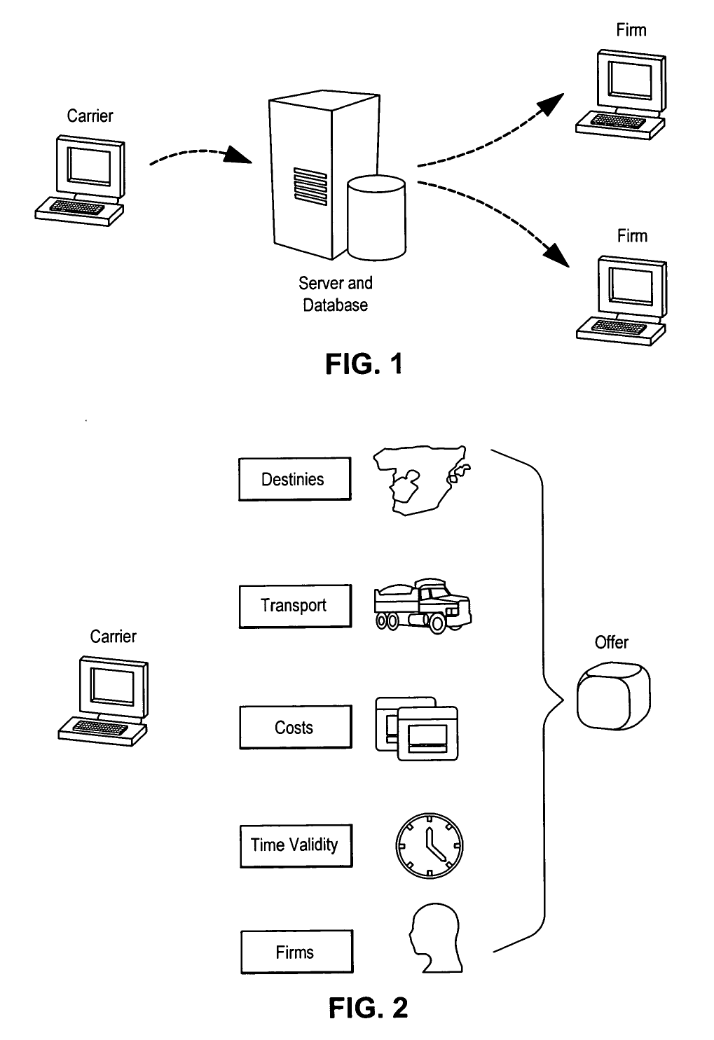

In FIG. 1 a carrier is sending one or more offers to a server (the described step c) directed to the two firms illustrated on the right of said FIG. 1, which are made available to them at said step d), for example for the embodiment relating Internet as the computer network, by exhibiting them at the firms computer's displays.

As for the offers, conveyed by the carriers in step c), is concerned, including load criterions, those can be one or more of the next load criterions, or a combination thereof:
destiny and origin of the transport offered,
type of load capable of transporting,
costs,
offer validity time period, and
kind and number of vehicles said carrier has.

FIG. 2 is an example of the contents of one of said offers, which are responsible for the cited personalization.

The computer program included in said main computing means, is in charge also of doing offers statistics by applying the method proposed, and show it to said carrier, by using said graphical environment, their own displays.

As said above said information items provided at said step a) includes in addition a firm filtering criterion, which can be for example one of the next filtering criterions, or a combination thereof:
carriers black lists,
costs limits,
kind of vehicles to be used, and
load destination and origin.

Said previous sorting is carried out according to said firm filtering criterion and/or other criterion known by said main computing means.

Referring to the mentioned detail of at least one geographical zone of step a), this is generally represented by a map reflecting the load necessities of each firm in one or more geographical areas, enabling to prepare an offer and graphically attach it to each zone. The way of representation can be diverse but at any case allowing to use any of the geographical o local areas to attach to it a particular offer to the carrier when consulting the map.

In a particular embodiment said map easies the carriers to provide to the main computing means the information referring the required transport destinations, by just clicking on a part of said map (or more than one if for example two countries or cities, o near areas are required as destinations).

Now following with the steps of the method, it comprises for each of said firms, after said step d):

e) receive in a firm computing means, connected to said main computing means, said personalized offers, and

f) using said firm computing means and at least input and display means, and resources of said at least one computing program at said main computer means, perform at least one of following tasks:
a filtering of said received offers according to said firm filtering criterion or another filtering criterion, automatically or requested by said firm, and show the offers resulting from said filtering;
a comparison of said received offers to group at least some of them according to their similarity, and show the result of said comparison; and
an exhibition through said display means, of historic effectiveness data relating to the carriers which have sent said offers, if said carriers have transported any load of the firm previously.

The method also comprises, after said step f), for each firm:

g.1) choose one of said personalized offers received at step e), the one which best fits the firm needing, and send a transport order, through said main computing means, to the carrier which has sent said offer, or

g.2) choose at least two of said personalized offers received at step e), and send a respective transport order, directly or through said main computing means, to the carriers which have sent said offers.

This last step g.2) is the preferred (over g.1) to be carried out by the method proposed, so it reflects the case that two or more of the offers provided by two or more respective carriers are considered as fitting the firm needs.

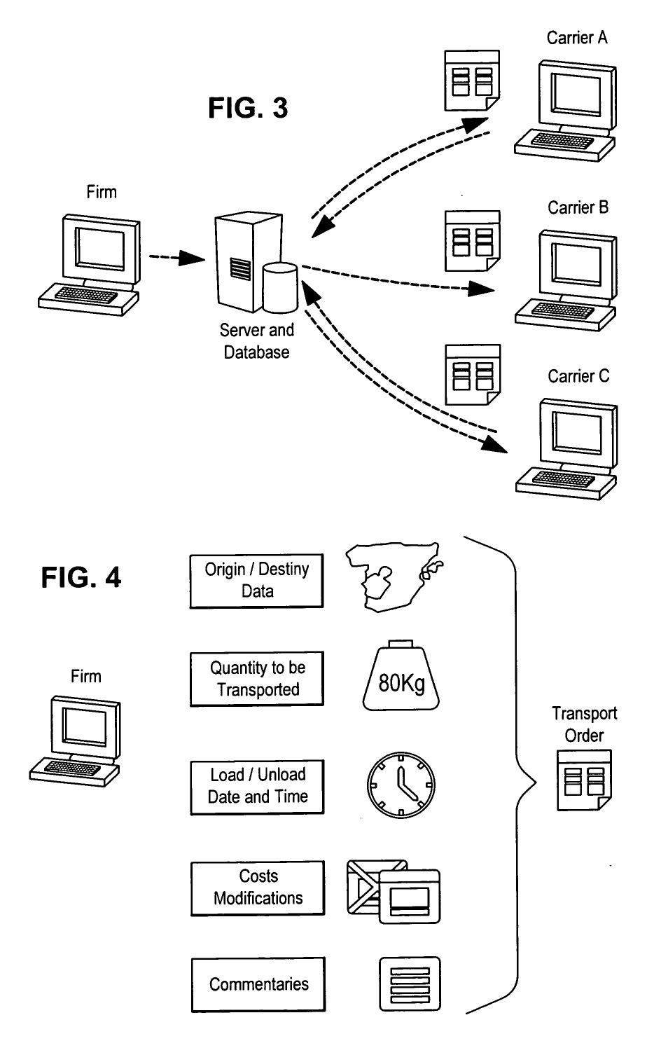

Once a firm has chosen said two or more offers, said firm sends a transport order to the carriers which have sent them, situation which is illustrated by FIG. 3, wherein an order is being sent, through the server, to three carriers, indicated as A, B and C, action which is indicated by the dotted arrows directing to the right. In that FIG. 3 only carriers A and C respond (dotted arrows directing to the left), while carrier B doesn't respond at all. There are three possible actions to be taken by the carriers which will be explained in detail below.

For a particular embodiment said transport order includes data relating to one or, preferably, more than one of the next data fields, or a combination thereof:
origin and destiny identifying data, comprising information regarding at least country, province, city, street, phone number, or a combination thereof, and
load characteristics, comprising information relating to at least weight, dimensions and type of loads.
load and unload time schedule,
cost modifications, and
commentaries.

An example of one of said transport orders is illustrated by FIG. 4.

The method comprises, after said step g.2):

h) receive each of said at least two carriers, in respective carriers computing means, connected to said main computing means, said transport order directed to it, and the mentioned actions to be taken by the carriers when they receive an order, i.e.:

i.1) send an acceptation or confirmation of said transport order to the user who has sent it, or

i.2) send a refusing of said transport order to the user who has sent it, or

i.3) send suggestions relating to modifications of said transport order.

The method also comprises to send information about steps i.1) to i.3) at least to said main computing means where it is available to the corresponding firm at any given moment to enable the firm to verify the evolution of the order corresponding to the executed offer.

After receiving one or more transport order acceptations, the method proposed comprises qualifying as considered completed the transport order once the load to be transported referred in that order, has been transported by the carrier to which a transport order confirmation has been sent, and a confirmation of delivery is received.

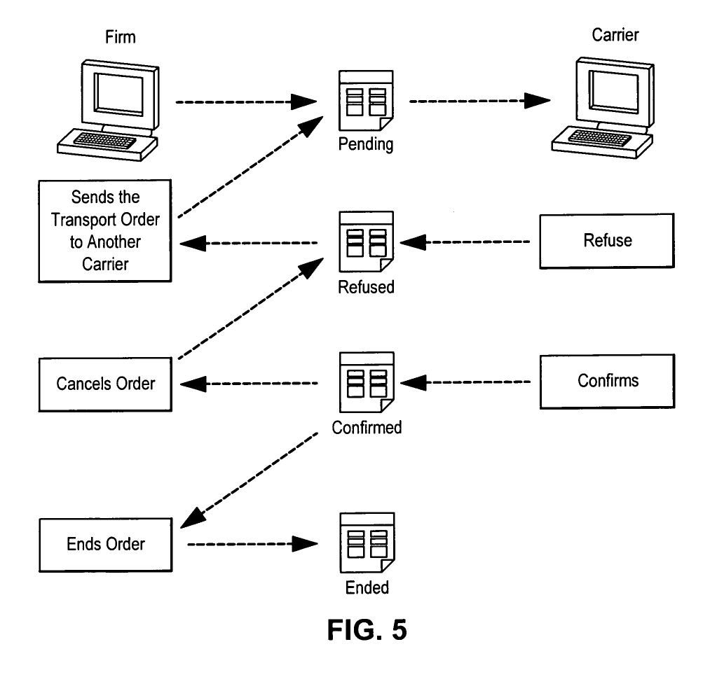

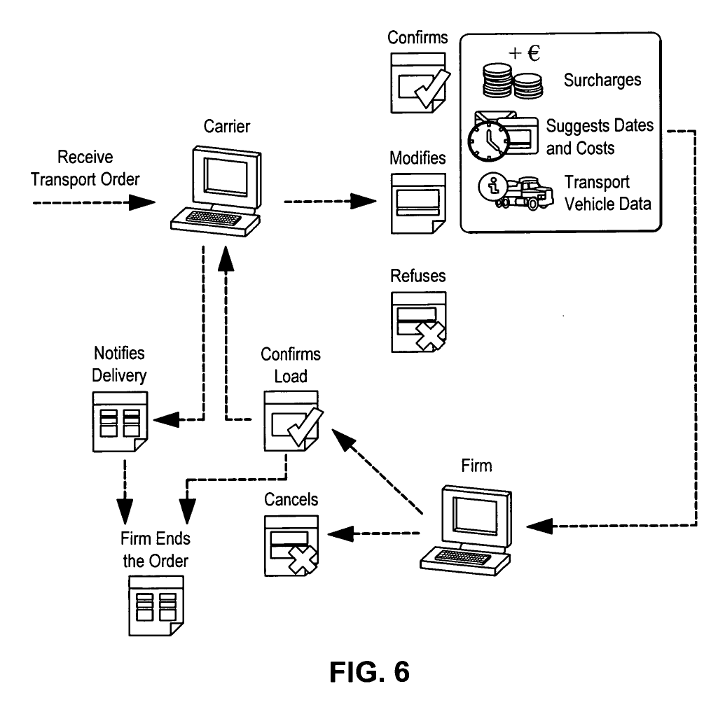

FIGS. 5 and 6 illustrates the communication between a firm and a carrier and the actions carried out by each other related to the described steps of the method proposed.

First referring to FIG. 5 the firm there represented, on the left, sends a transport order to the carrier illustrated on the right.

The icon of a “paper sheet” represents that order in the different states it passes through the steps of the method.

The first state of the order is a pending state, so the firm is waiting for an answer from the carrier.

One of the possible answers of the carrier is to refuse the order (i.2), then sending the firm, in response, the order to another carrier.

Another possible answer of the carrier is to confirm the order (i.1), then the firm cancels the orders sent to other carriers, if any, accepts the one confirmed, and ends the order (ended state).

In the embodiment illustrated by FIG. 6, the carrier receives a transport order, and carries out one of the mentioned actions represented by steps i.1), i.2) and i.3) (examples of the latter illustrated in FIG. 6: Surcharges, suggest dates, etc.).

The firm there illustrated is confirming a load (a transport order) while canceling another order directed to another carrier.

In that FIG. 6 the carrier is receiving said order confirmation, it carries out the work, i.e. load and transport the required load (action not indicated in FIG. 6), and when it has finished said work it send a delivery notification of that fact, preferably to the server, and the firm can see it by accessing the server and looking at the mentioned graphical environment. Then is when the firm ends the transport order.

For another embodiment, not shown, by applying the method proposed, firms can, in addition, provide to the main computing means, at a given moment, at least one request, per firm, for a particular load service needed in a particular geographical zone.

For said embodiment carriers can, in addition, access the computing means to receive the load requests, from said load services requests, which refer to the geographical zones desired by the firms, or the ones which are closest to said desired geographical zones.

The program controlling the method exposed also allow to monitor any part of the process from the launch of an offer to the completion of the transportation service related to.

An expert in the state of the art could introduce changes and modifications in the described preferred embodiments without leaving aside the scope of the invention as defined by the enclosed claims.

1. A method for the management of offers related to load transportation services, said load transportation services being needed by a plurality of firms and said services being provided by a plurality of carriers, the method comprising:
a) providing to main computing means or a server a list of information relating to firms needing transportation services, said information including, per firm, at least a firm identifier and at least detail of one geographical zone or area including at least a transport destination;
b) making available said information about firm transport requirements to carriers, said carriers also providing to said main computing means information including, per carrier, at least a carrier identifier and carrying capacity;
c) conveying said carriers to said main computing means, offers to any number of said firms, each offer containing at least a part being personalized by including at least a carrier load criterion including said at least one geographical zone of transport destinations required by the corresponding firm; and
d) making available said personalized offers to said firms they are directed to, using a computer network to realize said steps a), b) and c) of providing and making available said information and conveying said offers.

2. The method according to claim 1, wherein prior to said step d) processing through at least a computer program said personalized offers, said at least one carrier load criterion and said list of firms information items using at least part of said main computing means to create a database of offers related to firms.

3. The method according to claim 1, wherein said step d) includes sending said offers to corresponding firms under petition thereof.

4. The method according to claim 2, further comprising sorting said personalized offers, automatically or requested by a firm by said main computing means, prior to said step d) and said working on said database of offers related to firms.

5. The method according to claim 4, wherein said information items provided at said step a) further includes a firm filtering criterion.

6. The method according to claim 5, wherein said sorting is carried out according to said firm filtering criterion and/or predetermined criterion stored in said main computing means.

7. The method according to claim 1 or 2, wherein said detail of at least one geographical zone of step a) is represented by a map reflecting the load necessities of each firm in one or more geographical areas, enabling to prepare an offer and graphically attach it to each zone.

8. The method according to claim 5, further comprising for each of said firms, after said step d):
e) receiving in a firm computing means, connected to said main computing means, said personalized offers, and
f) using said firm computing means at least input and display means, and resources of said at least one computer program at said main computer means, to perform at least one of:
a filtering of said received offers according to said firm filtering criterion or another filtering criterion, automatically or requested by said firm, and show the offers resulting from said filtering;
a comparison of said received offers to group at least some of them according to their similarity, and show the result of said comparison; and
an exhibition through said display means, of historic effectiveness data relating to the carriers which have sent said offers, if said carriers have transported any load of the firm previously under order.

9. The method according to claim 8, further comprising after said step f), for each firm:
g.1) choosing one of said personalized offers received at step e), the one which best fits the firm needing, and send a transport order, through said main computing means, to the carrier which has sent said offer, or
g.2) choosing at least two of said personalized offers received at step e), and sending a respective transport order, through said main computing means, to the carriers which have sent said offers.

10. The method according to claim 9, further comprising after said step g.2):
h) receiving each of said at least two carriers, in respective carriers computing means, connected to said main computing means, said transport order directed to it, and:
i.1) sending an acceptation of said transport order to the user who has sent it, or
i.2) sending a refusing of said transport order to the user who has sent it, or
i.3) sending suggestions relating to modifications of said transport order.

11. The method according to claim 10, wherein information about steps i.1) to i.3) is sent to at least to said main computing means where it is available to the corresponding firm at said main computing means at any given moment to make a verification of the evolution of the offer.

12. The method according to claim 11, further comprising qualifying as considered completed the transport order once the load to be transported referred in that order, has been transported by the carrier to which a transport order confirmation has been sent, and a confirmation of delivery is received.

13. The method according to claim 1, wherein said carrier load criterion includes at least one of the next load criterions, or a combination thereof:
destiny and origin of the transport offered,
type of load capable of transporting,
costs,
offer validity time period, and
kind and number of vehicles said carrier has,

14. The method according to claim 5, wherein said firm filtering criterion includes at least one of the next filtering criterions, or a combination thereof:
carriers black lists,
costs limits,
kind of vehicles to be used, and
load destination and origin.

15. The method according to claim 9, wherein said transport order includes data relating to at least one of the next data fields, or a combination thereof:
origin and destiny identifying data,
load characteristics,
load and unload time schedule,
cost modifications, and
commentaries.

16. The method according to claim 15, wherein
said origin and destiny identifying data comprises information regarding at least one of country, province, city, street, phone number, or a combination thereof, and
said load characteristics comprises information relating to at least weight, dimensions and type of loads.

17. The method according to claim 2, wherein firms can, in addition, provide to the main computing means, at a given moment, at least one request, per firm, for a particular load service needed in a particular geographical zone.

18. The method according to claim 17, wherein carriers can, in addition, access the computing means to receive the load requests, from said load services requests, which refer to the geographical zones desired by the carriers, or the ones which are closest to said desired geographical zones.

19. The method according to claim 10, wherein all the steps of the method are exhibited by a graphical environment to the carriers and firms.

20. The method according to claim 1, wherein said computer network is global communication network.

21. The method according to claim 19, further comprising offering statistics and displaying said statistics via said graphical environment.
